(19) United States
(12) Patent Application Publication
(10) Pub. No.: US 2019/0300755 A1
(43) Pub. Date: Oct. 3, 2019

(54) THIN FOAM TAPES

(71) Applicant: 3M INNOVATIVE PROPERTIES COMPANY, St. Paul, MN (US)

(72) Inventor: Ross J. DeVolder, Woodbury, MN (US)

(21) Appl. No.: 16/467,556

(22) PCT Filed: Nov. 30, 2017
(86) PCT No.: PCT/IB2017/057554

§ 371 Date: Jun. 7, 2019

Related U.S. Application Data
(60) Provisional application No. 62/433,014, filed on Dec. 12, 2016.

(51) Int. Cl. C09J 7/26; C09J 7/38

(52) U.S. Cl. CPC C09J 7/26; C09J 7/38; C09J 2400/243; C09J 2203/326; C09J 2433/006; C09J 2453/006; C09J 2205/114

(57) ABSTRACT

A thin foam layer is provided comprising: a) a polymeric matrix; and dispersed therein b) expanded polymeric microspheres comprising a polymeric shell and a hollow interior; wherein the thin foam layer has a thickness of less than 325 microns, in some embodiments less than 200 microns, or in some embodiments less than 110 microns, and the expanded polymeric microspheres have an average diameter of less than 100 microns, or in some embodiments less than 50 microns. In some embodiments the thin foam layer comprises greater than 0.7 wt % expanded polymeric microspheres, and in some greater than 1.0 wt %. The present disclosure additionally provides tapes comprising the thin foam layer of the present disclosure.

### FIELD OF THE DISCLOSURE

This disclosure relates to thin foam layers which may be useful in thin pressure sensitive adhesive foam tapes.

### BACKGROUND OF THE DISCLOSURE

The following references may be relevant to the general field of technology of the present disclosure: U.S. Pat. Nos. 6,103,152; 9,200,129; US 2016/0083549 A1; US 2009/0181250 A1; DE 19531631 A1; US 2004/0131846 A1; U.S. Pat. No. 6,998,175.

### SUMMARY OF THE DISCLOSURE

Briefly, the present disclosure provides a thin foam layer comprising: a) a polymeric matrix; and dispersed therein b) expanded polymeric microspheres comprising a polymeric shell and a hollow interior; wherein the polymeric shell comprises a material different from the polymeric matrix; wherein the thin foam layer has a thickness of less than 325 microns; and wherein the expanded polymeric microspheres have an average diameter of less than 100 microns. In some embodiments, the thin foam layer has a thickness of less than 200 microns, in some embodiments less than 160 microns, in some embodiments less than 150 microns, in some embodiments less than 140 microns, in some embodiments less than 130 microns, in some embodiments less than 120 microns, and in some embodiments less than 110 microns. In some embodiments, the expanded polymeric microspheres have an average diameter of less than 80 microns, in some embodiments less than 70 microns, in some embodiments less than 60 microns, in some embodiments less than 50 microns, in some embodiments less than 40 microns, and in some embodiments less than 30 microns. In some embodiments the expanded polymeric microspheres exhibit a multimodal distribution of average diameter. In some embodiments the thin foam layer comprises greater than 0.1 wt % expanded polymeric microspheres, in some embodiments greater than 0.4 wt % expanded polymeric microspheres, in some embodiments greater than 0.7 wt % expanded polymeric microspheres, and in some embodiments greater than 1.0 wt % expanded polymeric microspheres. In some embodiments the polymeric matrix comprises a thermopolymer, e.g., a styrenic block copolymer, a polyurethane, or a (meth)acrylate polymer. In some embodiments the polymeric matrix comprises a pressure sensitive adhesive. The polymeric matrix optionally may additionally comprises one or more tackifiers, plasticizers, pigments or fillers. In some embodiments the thin foam layer has a density of less than 0.80 g/cm³, in some embodiments less than 0.78 g/cm³, and in some embodiments less than 0.76 g/cm³. In some embodiments the thin foam layer has a density that is less than 86% of the density of the polymer matrix, in some embodiments less than 84% of the density of the polymer matrix, and in some embodiments less than 82% of the density of the polymer matrix. In some embodiments the thin foam layer has a face comprising air release channels. Additional embodiments of the thin foam layer of the present disclosure are described below under “Selected Embodiments.”

In another aspect, the present disclosure provides tapes comprising the thin foam layer of the present disclosure and additionally comprising a first layer of adhesive borne on a first face of the thin foam layer. Optionally, a second face of the thin foam layer opposite the first face bears a second layer of adhesive. In other embodiments, the second face bears a layer of thermoplastic polymer. First and second layers of adhesive may be the same or different in composition, and may optionally be pressure sensitive adhesive, which may optionally comprise air release channels. In some embodiments, the tape has a thickness of less than 325 microns, in some embodiments less than 260 microns, in some embodiments less than 190 microns, and in some embodiments less than 160 microns. Additional embodiments of the tape of the present disclosure are described below under “Selected Embodiments.”

In another aspect, the present disclosure provides a portable electronic device comprising the thin foam layer or the tape according to the present disclosure. In some embodiments, the thin foam layer or tape is bound to a display screen, touch screen display, or organic light emitting diode (OLED) module. Additional embodiments of the portable electronic device of the present disclosure are described below under “Selected Embodiments.”

In this application:

“(meth)acrylate” refers to compounds containing an acrylate (CH₂═CH—C(O)O—) or a methacrylate (CH₂═CCH₃—C(O)O—) moiety, or moieties derived therefrom, e.g., by polymerization occurring at the carbon-carbon double bond, or combinations of the foregoing; and

“substituted” means, for a chemical species, group or moiety, substituted by conventional substituents which do not interfere with the desired product or process, e.g., substituents can be alkyl, alkoxy, aryl, phenyl, halo (F, Cl, Br, I), cyano, nitro, etc.

All scientific and technical terms used herein have meanings commonly used in the art unless otherwise specified.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

### BRIEF DESCRIPTION OF THE DRAWING

FIG. 1A is a micrograph of a surface of a comparative 100 micron thick foam layer, as described in the Examples below.

FIGS. 1B-1F are micrographs of surfaces of 100 micron thick foam layers according to the present disclosure, as described in the Examples below.

### DETAILED DESCRIPTION

The present disclosure provides thin foam layers which may be useful in thin pressure sensitive adhesive foam tapes. In some embodiments, such tapes comprise a foam inner layer bearing pressure sensitive adhesive layers on one or both faces. In some embodiments, such tapes comprise a foam layer which is itself a pressure sensitive adhesive.

When tape thickness is reduced sufficiently, such tapes can be used in small devices such as portable electronic devices, such as cell phones, tablets, and the like; e.g., for attachment or cushioning of display screens, touch screens, or organic light emitting diode (OLED) modules. However, reduction in tape thickness tends to increase defects and reduce the ability of the tape to contribute to impact resistance. Such applications additionally may require light weight components.

Surprisingly, we have found that impact performance in thin foam tapes can be improved with simultaneous reduction in defect generation and reduction in foam layer density.

Thin foam tapes according to the present disclosure have a thickness of less than 325 microns and in some embodiments less than 160 microns. They comprise foam layers having a thickness of less than 325 microns, in some embodiments less than 200 microns, and in some embodiments less than 110 microns. The foam layers are foams, i.e., comprise voids, due to the inclusion of expanded microspheres (EMS). In some embodiments, the EMS have an average expanded diameter of less than 80 microns; in some embodiments less than 50 microns, and in some embodiments less than 30 microns. In some embodiments, the EMS are present in the foam layer in an amount of greater than 0.3 weight percent, in some embodiments greater than 0.8 weight percent, and in some embodiments greater than 1.0 weight percent. In some embodiments, the EMS have an average expanded diameter of between 30 and 50 microns and are present in the foam layer in an amount of between 0.3 and 0.8 weight percent. In some embodiments, the EMS have an average expanded diameter of between 10 and 30 microns and are present in the foam layer in an amount of between 0.8 and 1.5 weight percent. In some embodiments, the EMS exhibit a multimodal distribution of average expanded diameter, e.g., a first mode of EMS having an average expanded diameter of between 30 and 50 microns and a second mode having a smaller average expanded diameter of between 10 and 30 microns.

### Selected Embodiments

The following embodiments, designated by letter and number, are intended to further illustrate the present disclosure but should not be construed to unduly limit this disclosure.
F1. A thin foam layer comprising:
   a) a polymeric matrix; and dispersed therein
   b) expanded polymeric microspheres comprising a polymeric shell and a hollow interior; wherein the polymeric shell comprises a material different from the polymeric matrix; wherein the thin foam layer has a thickness of less than 325 microns; and wherein the expanded polymeric microspheres have an average diameter of less than 100 microns.
F2. The thin foam layer according to any of the preceding embodiments wherein the thin foam layer has a thickness of less than 200 microns.
F3. The thin foam layer according to any of the preceding embodiments wherein the thin foam layer has a thickness of less than 160 microns.
F4. The thin foam layer according to any of the preceding embodiments wherein the thin foam layer has a thickness of less than 140 microns.
F5. The thin foam layer according to any of the preceding embodiments wherein the thin foam layer has a thickness of less than 130 microns.
F6. The thin foam layer according to any of the preceding embodiments wherein the thin foam layer has a thickness of less than 120 microns.
F7. The thin foam layer according to any of the preceding embodiments wherein the thin foam layer has a thickness of less than 110 microns.
F8. The thin foam layer according to any of the preceding embodiments wherein the thin foam layer has a thickness of greater than 50 microns.
F9. The thin foam layer according to any of the preceding embodiments wherein the expanded polymeric microspheres have an average diameter of less than 80 microns.
F10. The thin foam layer according to any of the preceding embodiments wherein the expanded polymeric microspheres have an average diameter of less than 70 microns.
F11. The thin foam layer according to any of the preceding embodiments wherein the expanded polymeric microspheres have an average diameter of less than 60 microns.
F12. The thin foam layer according to any of the preceding embodiments wherein the expanded polymeric microspheres have an average diameter of less than 50 microns.
F13. The thin foam layer according to any of the preceding embodiments wherein the expanded polymeric microspheres have an average diameter of less than 40 microns.
F14. The thin foam layer according to any of the preceding embodiments wherein the expanded polymeric microspheres have an average diameter of less than 30 microns.
F15. The thin foam layer according to any of the preceding embodiments wherein the expanded polymeric microspheres exhibit a multimodal distribution of average diameter.
F16. The thin foam layer according to embodiment F15 comprising at least one first mode of EMS having an average expanded diameter of between 10 and 30 microns and at least one second mode of EMS having an average expanded diameter of between 30 and 50 microns.
F17. The thin foam layer according to any of the preceding embodiments comprising greater than 0.1 wt % expanded polymeric microspheres.
F18. The thin foam layer according to any of the preceding embodiments comprising greater than 0.4 wt % expanded polymeric microspheres.
F19. The thin foam layer according to any of the preceding embodiments comprising greater than 0.7 wt % expanded polymeric microspheres.
F20. The thin foam layer according to any of the preceding embodiments comprising greater than 1.0 wt % expanded polymeric microspheres.
F21. The thin foam layer according to any of the preceding embodiments comprising less than 1.8 wt % expanded polymeric microspheres.
F22. The thin foam layer according to any of the preceding embodiments comprising less than 1.5 wt % expanded polymeric microspheres.
F23. The thin foam layer according to any of the preceding embodiments comprising less than 1.2 wt % expanded polymeric microspheres.
F24. The thin foam layer according to embodiment F14 comprising greater than 1.5 wt % expanded polymeric microspheres.
F25. The thin foam layer according to embodiment F14 comprising greater than 2.0 wt % expanded polymeric microspheres.
F26. The thin foam layer according to embodiment F14 comprising greater than 2.5 wt % expanded polymeric microspheres.
F27. The thin foam layer according to embodiment F14 comprising greater than 2.8 wt % expanded polymeric microspheres.
F28. The thin foam layer according to any of embodiments F24-F27 comprising less than 6.0 wt % expanded polymeric microspheres.
F29. The thin foam layer according to any of embodiments F24-F27 comprising less than 4.5 wt % expanded polymeric microspheres.
F30. The thin foam layer according to any of embodiments F24-F27 comprising less than 4.0 wt % expanded polymeric microspheres.
F31. The thin foam layer according to embodiment F14 comprising between 0.8 wt % and 6.0 wt % expanded polymeric microspheres.
F32. The thin foam layer according to embodiment F14 comprising between 0.8 wt % and 4.5 wt % expanded polymeric microspheres.
F33. The thin foam layer according to embodiment F14 comprising between 0.8 wt % and 4.0 wt % expanded polymeric microspheres.
F34. The thin foam layer according to embodiment F14 comprising between 0.8 wt % and 1.5 wt % expanded polymeric microspheres.
F35. The thin foam layer according to embodiment F12 comprising between 0.3 wt % and 0.8 wt % expanded polymeric microspheres.
F36. The thin foam layer according to embodiment F35 wherein the expanded polymeric microspheres have an average diameter of greater than 30 microns.
F37. The thin foam layer according to any of the preceding embodiments wherein the polymeric shell is a thermoplastic polymer.
F38. The thin foam layer according to any of the preceding embodiments wherein the polymeric shell comprises acrylonitrile copolymer.
F39. The thin foam layer according to any of the preceding embodiments wherein the polymeric matrix is a thermoplastic polymer.
F40. The thin foam layer according to any of the preceding embodiments wherein the polymeric matrix is a pressure sensitive adhesive.
F41. The thin foam layer according to any of the preceding embodiments wherein the polymeric matrix comprises styrenic block copolymer.
F42. The thin foam layer according to any of the preceding embodiments wherein the polymeric matrix comprises polyurethane polymer.
F43. The thin foam layer according to any of the preceding embodiments wherein the polymeric matrix comprises (meth)acrylate polymer.
F44. The thin foam layer according to any of the preceding embodiments wherein the polymeric matrix comprises greater than 90 wt % (meth)acrylate polymer.
F45. The thin foam layer according to any of the preceding embodiments wherein the polymeric matrix comprises greater than 95 wt % (meth)acrylate polymer.
F46. The thin foam layer according to any of the preceding embodiments wherein the polymeric matrix comprises greater than 99 wt % (meth)acrylate polymer.
F47. The thin foam layer according to any of the preceding embodiments wherein the polymeric matrix comprises greater than 99.8 wt % (meth)acrylate polymer.
F48. The thin foam layer according to any of embodiments F43-F47 wherein the (meth)acrylate polymer is a copolymer of a plurality of monomers selected from the group consisting of: acrylic acid, methacrylic acid, acrylic acid esters of alcohols and methacrylic acid esters of alcohols.
F49. The thin foam layer according to any of embodiments F43-F47 wherein the (meth)acrylate polymer is a copolymer of a plurality of monomers selected from the group consisting of: acrylic acid and acrylic acid esters of alcohols.
F50. The thin foam layer according to any of embodiments F48-F49 wherein said alcohols are selected from alcohols that are linear or branched.
F51. The thin foam layer according to any of embodiments F48-F50 wherein said alcohols are selected from alcohols that are saturated.
F52. The thin foam layer according to any of embodiments F48-F51 wherein said alcohols are selected from alcohols comprising 1-20 carbon atoms.
F53. The thin foam layer according to any of embodiments F48-F51 wherein said alcohols are selected from alcohols comprising 4-20 carbon atoms.
F54. The thin foam layer according to any of embodiments F48-F51 wherein said alcohols are selected from alcohols comprising 1-12 carbon atoms.
F55. The thin foam layer according to any of embodiments F48-F51 wherein said alcohols are selected from alcohols comprising 4-12 carbon atoms.
F56. The thin foam layer according to any of embodiments F48-F51 wherein said alcohols are selected from alcohols comprising 4-8 carbon atoms.
F57. The thin foam layer according to any of the preceding embodiments wherein the polymeric matrix additionally comprises one or more tackifiers.
F58. The thin foam layer according to any of the preceding embodiments wherein the polymeric matrix additionally comprises one or more plasticiers.
F59. The thin foam layer according to any of the preceding embodiments wherein the polymeric matrix additionally comprises one or more pigments.
F60. The thin foam layer according to any of the preceding embodiments wherein the polymeric matrix additionally comprises one or more fillers.
F61. The thin foam layer according to any of the preceding embodiments wherein the polymeric matrix additionally comprises particulate silica.
F62. The thin foam layer according to any of the preceding embodiments wherein the polymeric matrix additionally comprises particulate surface-modified silica.
F63. The thin foam layer according to any of the preceding embodiments wherein the polymeric matrix additionally comprises particulate fumed silica.
F64. The thin foam layer according to any of the preceding embodiments which has a density of less than 0.80 g/cm³.
F65. The thin foam layer according to any of the preceding embodiments which has a density of less than 0.78 g/cm³.
F66. The thin foam layer according to any of the preceding embodiments which has a density of less than 0.76 g/cm³.
F67. The thin foam layer according to any of the preceding embodiments which has a density that is less than 86% of the density of the polymer matrix.
F68. The thin foam layer according to any of the preceding embodiments which has a density that is less than 84% of the density of the polymer matrix.
F69. The thin foam layer according to any of the preceding embodiments which has a density that is less than 82% of the density of the polymer matrix.
F70. The thin foam layer according to any of the preceding embodiments having a face comprising air release channels.
T1. A tape comprising the thin foam layer according to any of embodiments F1-F70, wherein a first face of said thin foam layer bears a first layer of adhesive.
T2. The tape according to embodiment T1 wherein the first layer of adhesive is in direct contact with and bound to said first face of the thin foam layer.
T3. The tape according to embodiment T1 or T2 wherein a second face of said thin foam layer, opposite the first face of said thin foam layer, bears a second layer of adhesive.
T4. The tape according to embodiment T3 wherein the second layer of adhesive is in direct contact with and bound to said second face of the thin foam layer.
T5. The tape according to any of embodiments T3-T4 wherein the second layer of adhesive comprises the same adhesive as said first layer of adhesive.
T6. The tape according to any of embodiments T3-T4 wherein the second layer of adhesive comprises a different adhesive as said first layer of adhesive.
T7. The tape according to any of embodiments T3-T6 wherein the second layer of adhesive is a pressure sensitive adhesive.
T8. The tape according to any of embodiments T3-T7 wherein the second layer of adhesive has the same composition as the polymeric matrix.
T9. The tape according to any of embodiments T3-T7 wherein the second layer of adhesive has a different composition from the polymeric matrix.
T10. The tape according to any of embodiments T3-T9 wherein the second layer of adhesive comprises (meth)acrylate polymer.
T11. The tape according to any of embodiments T3-T10 wherein the second layer of adhesive has a thickness of less than 75 microns.
T12. The tape according to any of embodiments T3-T10 wherein the second layer of adhesive has a thickness of less than 50 microns.
T13. The tape according to any of embodiments T3-T10 wherein the second layer of adhesive has a thickness of less than 30 microns.
T14. The tape according to any of embodiments T3-T13 wherein the second layer of adhesive has an outer face comprising air release channels.
T15. The tape according to embodiment T1 or T2 wherein a second face of said thin foam layer, opposite the first face of said thin foam layer, bears a layer of thermoplastic polymer.
T16. The tape according to embodiment T15 wherein the layer of thermoplastic polymer is in direct contact with and bound to said second face of the thin foam layer.
T17. The tape according to embodiment T15 or T16 wherein the layer of thermoplastic polymer comprises polyurethane.
T18. The tape according to any of embodiments T1-T17 wherein the first layer of adhesive is a pressure sensitive adhesive.
T19. The tape according to any of embodiments T1-T18 wherein the first layer of adhesive has the same composition as the polymeric matrix.
T20. The tape according to any of embodiments T1-T18 wherein the first layer of adhesive has a different composition from the polymeric matrix.
T21. The tape according to any of embodiments T1-T20 wherein the first layer of adhesive comprises (meth)acrylate polymer.
T22. The tape according to any of embodiments T1-T21 wherein the first layer of adhesive has a thickness of less than 75 microns.
T23. The tape according to any of embodiments T1-T21 wherein the first layer of adhesive has a thickness of less than 50 microns.
T24. The tape according to any of embodiments T1-T21 wherein the first layer of adhesive has a thickness of less than 30 microns.
T25. The tape according to any of embodiments T1-T24 wherein the first layer of adhesive has an outer face comprising air release channels.
T26. The tape according to any of embodiments T1-T25 having a thickness of less than 325 microns.
T27. The tape according to any of embodiments T1-T25 having a thickness of less than 260 microns.
T28. The tape according to any of embodiments T1-T25 having a thickness of less than 190 microns.
T29. The tape according to any of embodiments T1-T25 having a thickness of less than 160 microns.
T30. The tape according to any of embodiments T1-T29 which has a tensile impact resistance as measured according to ASTM D5628 of greater than 0.60 J.
T31. The tape according to any of embodiments T1-T29 which has a tensile impact resistance as measured according to ASTM D5628 of greater than 0.65 J.
T32. The tape according to any of embodiments T1-T29 which has a tensile impact resistance as measured according to ASTM D5628 of greater than 0.68 J.
T33. The tape according to any of embodiments T1-T29 which has a tensile impact resistance as measured according to ASTM D5628 of greater than 0.71 J.
E 1 . A portable electronic device comprising the tape according to any of embodiments T1-T33.
E2. The device according to embodiment El wherein said tape is bound to a display screen.
E3. The device according to embodiment El wherein said tape is bound to a touch screen display.
E4. The device according to embodiment El wherein said tape is bound to an OLED module.
E5. A portable electronic device comprising the thin foam layer according to any of embodiments F1-F70.
E6. The device according to embodiment E5 wherein said thin foam layer is bound to a display screen.
E7. The device according to embodiment E5 wherein said thin foam layer is bound to a touch screen display.
E8. The device according to embodiment E5 wherein said tape is bound to an OLED module.

Objects and advantages of this disclosure are further illustrated by the following examples, but the particular materials and amounts thereof recited in these examples, as well as other conditions and details, should not be construed to unduly limit this disclosure.

### EXAMPLES

Unless otherwise noted, all reagents were obtained or are available from Aldrich Chemical Co., Milwaukee, Wis., or may be synthesized by known methods.

### Materials

| | |
|---|---|
| AA | Acrylic acid |
| EHA | 2-ethyl hexyl acrylate |
| KRATON | A styrene-isoprene-styrene triblock copolymer having an approximate styrene |
| 1161 | content of 15% and 19% diblock content, available under the trade |
| | designation KRATON D1161 P from Kraton Performance Polymers, |
| | Houston, TX. |
| FORAL 85 | A glycerol ester of highly hydrogenated refined wood rosin, available under |
| | the trade designation FORAL 85 from Pinova Corporation, Brunswick, GA. |
| IRG1010 | Pentaerythritoltetrakis(3-(3,5-ditertbutyl-4-hydroxyphenyl)propionate), an |
| | antioxidant available under the trade designation IRGANOX 1010 available |
| | from BASF Corporation, Florham Park, NJ. |
| IRG651 | 2-dimethoxy-2-phenylacetophenone, a photoinitiator available under the trade |
| | designation IRGACURE 651 from available from BASF Corporation, |
| | Florham Park, NJ. |
| Test Panel 1 | Acrylic sheets with abrasive resistant coating cut to the dimensions of 3 mm |
| | (0.118 inch) × 50.8 mm (2 inches) × 101.6 mm (4 inches), available under the |
| | trade designation ACRYLITE AR from Evonik Corporation, Parisippany, NJ. |
| Test Panel 2 | Acrylic sheets with abrasive resistant coating cut to the dimensions of 6 mm |
| | (0.236 inch) × 50.8 mm (2 inches) × 101.6 mm (4 inches), available under the |
| | trade designation ACRYLITE AR from Evonik Corporation, Parisippany, NJ. |
| Release Liner 1 | A 0.003 in. (75 micrometer) thick polyester release liner having a different |
| | release coating on each side to provide a differential release. |
| Adhesive | 3M 9458 Transfer Tape, 0.001 in (25 micrometers) thick acrylic adhesive on |
| Transfer | a 0.003 in. (75 micrometer) thick polyester release liner having a different |
| Tape 1 | release coating on each side to provide a differential release. |
| EMS 185 | Heat-expandable polymeric microspheres consisting of an acrylonitrile |
| | copolymer shell which encapsulates a high boiling point liquid having an |
| | average pre-expansion particle diameter of 20 to 30 microns, available under |
| | the trade designation DUALITE ® U010-185D from Chase Corporation, |
| | Westwood, MA. After expansion, average particle diameter is 185 microns. |
| EMS 40 | Heat-expandable polymeric microspheres consisting of a shell encapsulating a |
| | gas having an average pre-expansion particle diameter of 10 to 16 microns |
| | available under the trade designation EXPANCEL 920DU40 from |
| | AkzoNobel Corporation, Amsterdam, Netherlands. After expansion, average |
| | particle diameter is 40 microns. |
| EMS 20 | Heat-expandable polymeric microspheres consisting of a shell encapsulating a |
| | gas having an average pre-expansion particle diameter of 5 to 9 microns |
| | available under the trade designation EXPANCEL 920DU20 from |
| | AkzoNobel Corporation, Amsterdam, Netherlands. After expansion, average |
| | particle diameter is 20 microns. |

### Test Methods

### Foam Density Measurements

The density of samples without laminated adhesives or electron beam irradiation were measured using a Mettler Toledo DENSITY KIT on a Mettler Toledo XP/XS ANALYTICAL BALANCE. Foam samples were folded two times creating four layer constructs. The four layer constructs were cut into 25.5 mm (1 inch) by 25.5 mm (1 inch) squares. The density of the constructs were measured using a Mettler Toledo DENSITY KIT on a Mettler Toledo XP/XS ANALYTICAL BALANCE according to manufacturer protocol. Three measurements were taken per example condition and the average density is reported.

### Tensile Drop Test

Test Panel 1 was washed three times with isopropanol. Two strips of foam sample measuring 2 mm by 51 mm were applied lengthwise across the width of the underside cavity of a custom made aluminum test fixture having a weight of 143 grams such that they were 11.5 mm from the end walls of the cavity. The Test Panel 1 was centered within the cavity and in contact with the adhesive foam strips. The bonded article was then positioned with the cavity facing upward and a 4 kg (8.8 lb.) weight was placed on the exposed surface of Test Panel 1 for 15 seconds after which it was removed and the bonded article was allowed to dwell for 24 hours at 23° C. and 50% RH. The bonded article was then evaluated for drop resistance in a tensile mode using a drop tester (DT 202, available from Shinyei Corporation of America, New York, N.Y.) and a horizontal orientation of the bonded article with Test Panel 1 facing downward. The bonded article was dropped onto a 1.2 cm thick steel plate until failure starting at a height of 70 cm for 30 drops, then 120 cm for 30 additional drops, and finally 200 cm for 30 drops. Two samples were tested, the number of drops to failure recorded for each, and the average number of drops to failure was reported. The method and drop assembly is described in U. S. Published Patent Application No. 2015/0030839.

### Tensile Impact Resistance Test

The impact resistance of tape samples were measured according to ASTM D5628. A 184 mm² tape sample was applied between two 3 mm thick flat stainless steel panels. A 6.5 kg weight was placed on top of the bonded article for 2 minutes then removed after which the bonded article was allowed to dwell for 48 hours at 23° C. and 50% relative humidity (RH). Next, the bonded article was impacted using an Instron CEAST 9340 by dropping a 2.98 kg weight from a height of 115 cm. The total impact energy (total energy) required to debond the stainless steel substrates, was measured and recorded. Three measurements were taken for each example, and the average total energy was reported.

### Preparation of Acrylic Copolymer (AC1)

An acrylic copolymer (AC1) was prepared having the compositions shown in Table 1. For the copolymer, the components in the amounts shown in Table 1 were mixed in amber bottles. Approximately 26 grams of the mixture were placed in a 18 cm×5 cm clear heat sealable poly(ethylene vinyl acetate) bag obtained under the trade designation VA-24 from Flint Hills Resources; Wichita, Kans. Air was forced out of the open end and the bag was sealed using an impulse heat sealer (Midwest Pacific Impulse Sealer; J. J. Elemer Corp.; St. Louis, Mo.). The sealed bags were immersed in a constant temperature water bath at 17° C. and irradiated with ultraviolet light (365 nm, 4 mW/cm²) for eight minutes on each side to produce the acrylic copolymer. The method of forming the packages and curing are described in Example 1 of U. S. Pat. No. 5,804,610, the subject matter of which is incorporated herein by reference in its entirety.

TABLE 1
Compositions of acrylic copolymer (in parts by weight)

| Polymer | EHA | AA | IRG651 |
|---|---|---|---|
| AC1 | 94 | 6 | 0.15 |

### Preparation of Samples

### Example C1

Comparative sample, C1, was prepared by feeding KRATON 1161, AC1, FORAL 85 and IRG1010 into a co-rotating twin screw extruder at 1.54 kg/hr (3.4 lbs/hr), 1.54 kg/hr (3.4 lbs/hr), 1.27 kg/hr (2.8 lbs/hr), and 0.086 kg/hr (0.19 lbs/hr), respectively. The ingredients were compounded in the extruder at a temperature of 115° C., and subjected to 250 rotations per minutes. The compounded ingredients were metered using a gear-pump and extruded through a die at 160° C. The resulting extrudate was cast onto Release Liner 1 at a thickness of 100 microns. Subsequently, Release Liner 1 was removed from the foam sample and Adhesive Transfer Tape 1 was laminated to both sides, resulting in a three layer foam tape construction having a thickness of 150 microns. The three layer sample was exposed to e-beam radiation on each side using an ELECTROCURTAIN CB-300 e-beam unit (Energy Sciences Incorporated, Wilmington, Mass.) at an accelerating voltage of 250 Kiloelectron Volts, and a dose of 4 MegaRads per side.

TABLE 2
Expandable microsphere (EMS) concentration

| Example | EMS Added, wt % | EMS Type |
|---|---|---|
| C1 | none | none |
| C2 | 0.51 | EMS185 |
| C3 | 0.81 | EMS185 |
| E4 | 0.51 | EMS40 |
| E5 | 1.01 | EMS40 |
| E6 | 2.00 | EMS40 |
| E1 | 0.51 | EMS20 |
| E2 | 1.01 | EMS20 |
| E3 | 2.97 | EMS20 |

In Table 2, “wt %” is a weight percent of expandable microspheres with respect to the total weight of the foam layer composition.

### Examples C2-C3

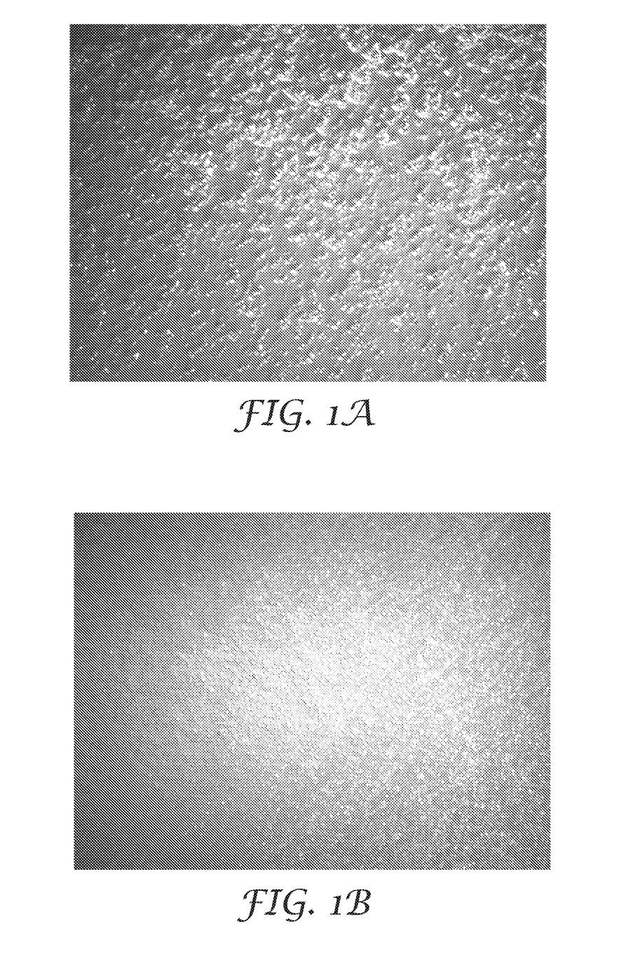

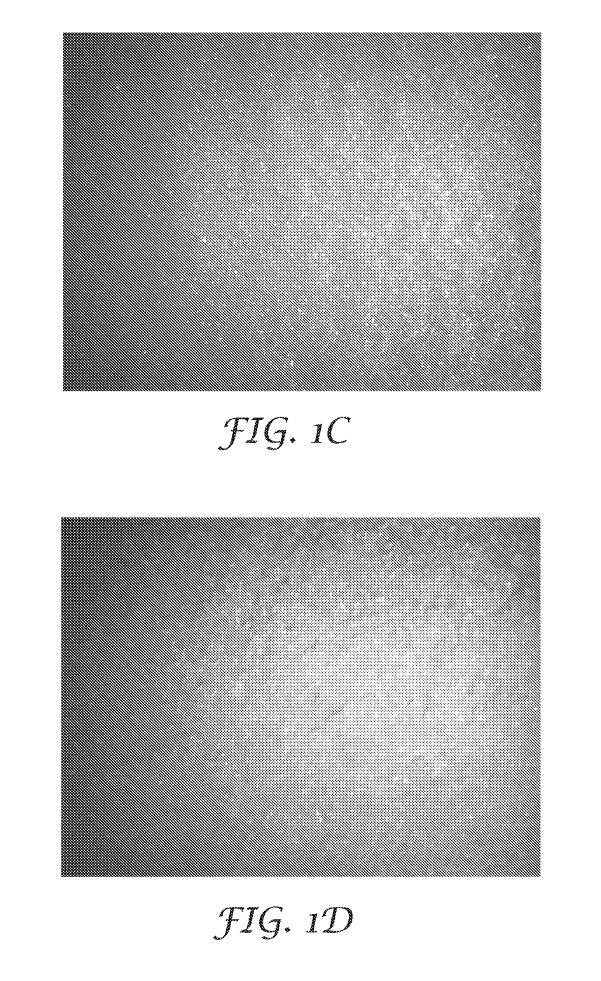

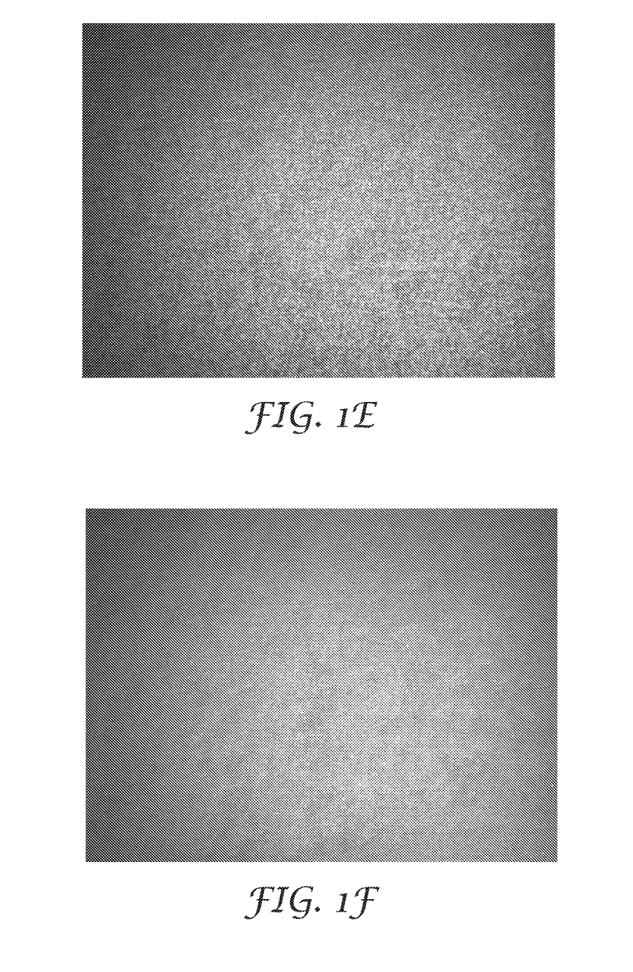

Comparative examples C1 and C2 were made according to the procedure for C1, with the following modifications: EMS185 was added to the compounded ingredients, as listed in Table 2. FIG. 1A is a micrograph of the surface of C2 taken with a Nikon SMZ1500 stereomicroscope at a magnification of 150×. FIG. 1A demonstrates that the surface of the 100 micron thick foam layer C2 was rough and only marginally acceptable. C3 was unusable due to defects created by the addition of EMS to the 100 micron thick foam layer C3.

### Examples E1 -E3

Examples E1 through E3 were made according to the procedure for C1, with the following modifications: EMS40 was added to the compounded ingredients, as listed in Table 2. FIGS. 1B and 1C are micrographs of the surfaces of E1 and E2 respectively, taken with a Nikon SMZ1500 stereomicroscope at a magnification of 150×. FIGS. 1B and 1C demonstrate that the surfaces of the 100 micron thick foam layers E1 and E2 were smooth. E3 was unusable due to defects created by the addition of EMS to the 100 micron thick foam layer E3.

### Examples E4-E6

Examples E4 through E6 were made according to the procedure for C1, with the following modifications: EMS20 was added to the compounded ingredients, as listed in Table 2. FIGS. 1D, 1E and 1F are micrographs of the surfaces of E4, E5 and E6 respectively, taken with a Nikon SMZ1500 stereomicroscope at a magnification of 150×. FIGS. 1D, 1E and 1F demonstrate that the surfaces of the 100 micron thick foam layers E4, E5 and E6 were smooth.

### Results

TABLE 3
Density, Tensile Drop, Compression Drop
and Tensile Impact measurements

| | | | | | | | | Tensile |
|---|---|---|---|---|---|---|---|---|
| | | | | | Tensile Drop | | | Impact |
| | | | | | # at | # at | # at | Total |
| | Surface | EMS | EMS | Density | 70 | 120 | 200 | Energy, |
| Ex | picture | wt % | size | g/cm³ | cm | cm | cm | J |
| C1 | none | 0.00 | (none) | 0.93 | 14.5 | 4 | — | 0.48 |
| C2 | FIG. 1A | 0.51 | EMS185 | 0.82 | 30 | 7 | — | 0.57 |
| C3 | none | 0.81 | EMS185 | NT | NT | NT | NT | NT |
| E1 | FIG. 1B | 0.51 | EMS40 | 0.87 | 30 | 30 | 10 | 0.75 |
| E2 | FIG. 1C | 1.01 | EMS40 | 0.79 | 30 | 15 | — | 0.72 |
| E3 | none | 2.00 | EMS40 | NT | NT | NT | NT | NT |
| E4 | FIG. 1D | 0.51 | EMS20 | 0.85 | 30 | 19 | 12 | 0.70 |
| E5 | FIG. 1E | 1.01 | EMS20 | 0.83 | 30 | 16.5 | 6 | 0.74 |
| E6 | FIG. 1F | 2.97 | EMS20 | 0.75 | 30 | 13 | — | 0.66 |

In Table 3, “#” represents the average number of drops to failure; “-” indicates that the 200 cm drop level was not tested, since fewer than 30 drops passed at the 120 cm drop level; and “NT” represents “not tested”, due to poor coating quality from defects created by the added EMS.

Comparison of C2, E1 and E4 demonstrates that replacing 185 micron EMS with an equal weight of 40 micron EMS or 20 micron EMS improves the tensile impact results and the tensile drop results measured at greater heights (such as 120 cm), in addition to improving surface smoothness. Comparison of C2 and E5 demonstrates that replacing 185 micron EMS with an amount of 20 micron EMS sufficient to provide approximately the same density reduction improves the tensile impact results and the tensile drop results measured at greater heights (such as 120 cm), in addition to improving surface smoothness.

Comparison of C3, E2 and E5 demonstrates that the 40 micron EMS and 20 micron EMS can be loaded in greater amounts than 185 micron EMS without creating unacceptable defects. Comparison of E3 and E6 demonstrates that the 20 micron EMS can be loaded in greater amounts than 40 micron EMS without creating unacceptable defects.

Comparison of C2-3 and E1-3 demonstrates that greater reduction in density can be achieved while improving tensile impact results by use of the 40 micron EMS instead of 185 micron EMS. Comparison of C2-3 and E4-6 demonstrates that greater reduction in density can be achieved while improving tensile impact results by use of the 20 micron EMS instead of 185 micron EMS. Comparison of E1 and E5 demonstrates that greater reduction in density can be achieved with a comparable improvement in tensile impact results by use of the 20 micron EMS instead of 40 micron EMS.

Various modifications and alterations of this disclosure will become apparent to those skilled in the art without departing from the scope and principles of this disclosure, and it should be understood that this disclosure is not to be unduly limited to the illustrative embodiments set forth hereinabove.

1. A tape comprising a thin foam layer comprising:
a) a polymeric matrix; and dispersed therein
b) expanded polymeric microspheres comprising a polymeric shell and a hollow interior;
wherein the polymeric shell comprises a material different from the polymeric matrix;
wherein the thin foam layer has a thickness of less than 325 microns; and
wherein the expanded polymeric microspheres have an average diameter of less than 100 microns,
wherein a first face of said thin foam layer bears a first layer of adhesive.

2. The tape according to claim 1 wherein the thin foam layer has a thickness of less than 160 microns.

3. The tape according to claim 1 wherein the thin foam layer has a thickness of less than 110 microns.

4. The tape according to claim 1 wherein the expanded polymeric microspheres have an average diameter of less than 50 microns.

5. The tape according to claim 1 wherein the expanded polymeric microspheres have an average diameter of less than 30 microns.

6. The tape according to claim 1 wherein the expanded polymeric microspheres exhibit a multimodal distribution of average diameter.

7. The tape according to claim 1 wherein the thin foam layer comprises greater than 0.7 wt % expanded polymeric microspheres.

8. The tape according to claim 1 wherein the thin foam layer comprises greater than 1.0 wt % expanded polymeric microspheres.

9. The tape according to claim 1 wherein the polymeric matrix comprises (meth)acrylate polymer.

10. The tape according to claim 1 wherein the polymeric matrix comprises styrenic block copolymer.

11. The tape according to claim 1 wherein the thin foam layer has a density that is less than 86% of the density of the polymer matrix.

12. The tape according to claim 1 wherein the thin foam layer has a density that is less than 82% of the density of the polymer matrix.

14. The tape according to claim 1 wherein a second face of said thin foam layer, opposite the first face of said thin foam layer, bears a second layer of adhesive.

15. The tape according to claim 1 wherein the first layer of adhesive is a pressure sensitive adhesive.
